(19) United States
(12) Patent Application Publication
(10) Pub. No.: US 2021/0154932 A1
(43) Pub. Date: May 27, 2021

(54) LIQUID DISCHARGE HEAD, LIQUID DISCHARGE APPARATUS, AND METHOD FOR PRODUCING LIQUID DISCHARGE HEAD

(71) Applicants: Tatsuya SAMESHIMA, Kanagawa (JP); Hidekazu YAGINUMA, Kanagawa (JP); Takahiko MATSUMOTO, Kanagawa (JP); Momoko SHIONOIRI, Kanagawa (JP); Natsuko IWASHITA, Tokyo (JP); Chihiro KUBO, Kanagawa (JP); Naoki SATOH, Kanagawa (JP); Takehiro YAMAZAKI, Kanagawa (JP)

(72) Inventors: Tatsuya SAMESHIMA, Kanagawa (JP); Hidekazu YAGINUMA, Kanagawa (JP); Takahiko MATSUMOTO, Kanagawa (JP); Momoko SHIONOIRI, Kanagawa (JP); Natsuko IWASHITA, Tokyo (JP); Chihiro KUBO, Kanagawa (JP); Naoki SATOH, Kanagawa (JP); Takehiro YAMAZAKI, Kanagawa (JP)

(21) Appl. No.: 16/950,133

(22) Filed: Nov. 17, 2020

(30) Foreign Application Priority Data
Nov. 25, 2019 (JP) 2019-211965

(51) Int. Cl. B29C 64/209; B33Y 30/00; B33Y 70/00

(52) U.S. Cl. CPC B29C 64/209; B33Y 70/00; B33Y 30/00

(57) ABSTRACT

A liquid discharge head including: a film member including a discharge hole configured to discharge liquid; and a displacement member configured to displace a position of the film member to discharge the liquid from the discharge hole, wherein an edge of the film member forming the discharge hole has a curve in a cross section of the film member in a thickness direction of the film member, and a surface of the film member includes a passive film.

### CROSS-REFERENCE TO RELATED APPLICATIONS

The present application claims priority under 35 U.S.C. § 119 to Japanese Patent Application No. 2019-211965, filed Nov. 25, 2019. The contents of which are incorporated herein by reference in their entirety.

### BACKGROUND OF THE INVENTION

### Field of the Invention

The present disclosure relates to a liquid discharge head, a liquid discharge apparatus, and a method for producing the liquid discharge head.

### Description of the Related Art

In recent years, such a technique that a cell solution containing cells is discharged by an inkjet head to form a cell chip or a three-dimensional tissue has been actively developed.

Examples of types of the inkjet head include a piezoelectric pressurization type using a piezoelectric element, a thermal type using a heater, and an electrostatic type that pulls liquid through electrostatic attraction. Among them, a piezoelectric pressurization type inkjet head can be suitably used when liquid droplets of a cell solution are discharged because it hardly imparts damages caused by heat or electric field to the cells in comparison with inkjet heads of the other types.

However, because a general piezoelectric pressurization type inkjet head uses compression of liquid in a pressurization liquid chamber to form liquid droplets, the liquid is less compressed when bubbles are contained in the pressurization liquid chamber, and the liquid droplets cannot be formed in some cases.

Moreover, because a surfactant used in a general inkjet ink may impart damages to cells, it is difficult to contain it in a cell solution. Therefore, water is often used as a solvent in the cell solution. However, when water is used as a solvent, bubbles are easily included because water has a high surface tension.

In addition, when liquid (e.g., a cell solution) obtained by suspending, for example, particles is discharged by an inkjet head, the number of the particles contained in the discharged liquid droplet may vary greatly because of, for example, precipitation of the particles.

In order to solve these problems, a liquid droplet forming apparatus has been proposed, which includes an atmosphere open section configured to open the inside of a liquid retaining section to the atmosphere, and is configured to vibrate a film member in which a nozzle section is formed to form a liquid droplet (for example, see, Japanese Unexamined Patent Application Publication No. 2016-116489).

In order to prevent attachment and adhesion of ink components to the peripheral parts of a nozzle, coating the surface of a base material of the nozzle with a liquid repellent film has been proposed (for example, see, Japanese Unexamined Patent Application Publication Nos. 2001-55563 and 2015-3483).

### SUMMARY OF THE INVENTION

According to one aspect of the present disclosure, a liquid discharge head includes: a film member including a discharge hole configured to discharge liquid; and a displacement member configured to displace a position of the film member to discharge the liquid from the discharge hole. An edge of the film member forming the discharge hole has a curve in a cross section of the film member in a thickness direction of the film member. A surface of the film member includes a passive film.

### BRIEF DESCRIPTION OF THE DRAWINGS

FIG. 1A is a schematic top view of one example of a liquid discharge head of the present disclosure;

FIG. 1B is a schematic cross-sectional view of one example of a liquid discharge head of the present disclosure;

FIG. 1C is a schematic cross-sectional view of another example of a liquid discharge head of the present disclosure;

FIG. 1D is a schematic cross-sectional view of one example of a conventional liquid discharge head; and

FIG. 1E is a schematic cross-sectional view of another example of a liquid discharge head of the present disclosure.

### DETAILED DESCRIPTION OF THE INVENTION

### (Liquid Discharge Head)

A liquid discharge head (liquid discharge unit) of the present disclosure includes: a film member including a discharge hole configured to discharge liquid; and a displacement member configured to displace a position of the film member to discharge the liquid from the discharge hole. An edge of the film member forming the discharge hole has a curve in a cross section of the film member in a thickness direction of the film member. A surface of the film member includes a passive film. The liquid discharge head of the present disclosure preferably further includes a fixing member, a liquid storage chamber, electrodes, a lid member, and a connection member, and further includes other members if necessary.

An object of the present disclosure is to provide a liquid discharge head that has a simple structure and can discharge various liquids continuously and stably.

According to the present disclosure, it is possible to provide a liquid discharge head that has a simple structure and can discharge various liquids continuously and stably.

The liquid discharge head of the present disclosure is based on the following finding. That is, in a conventional liquid discharge head, components in ink (e.g., cells, components that react with, for example, a Si—OH group) adhere to a discharge hole (nozzle) or its vicinity to disturb formation of meniscus. As a result, an intended meniscus cannot be obtained, and discharge defects such as overflow of ink from the discharge hole (nozzle) may be caused in some cases.

The liquid discharge head of the present disclosure is based on the following finding. That is, when the conventional liquid discharge head uses ink that cannot contain, for example, a surfactant, it is difficult to control a surface tension of the ink (object to be discharged) and to maintain stable discharging while meniscus formed near the discharge hole (nozzle) is controlled.

The present inventors diligently studied, for example, a liquid discharge head that has a simple structure and can solve the aforementioned problems, and conceived the present disclosure. That is, the present inventors found that a liquid discharge head of the below-described embodiment can discharge liquid with a simple structure and can discharge various liquids stably and continuously.

### <Film Member>

The film member (film upper part) is not particularly limited and may be appropriately selected depending on the intended purpose so long as it includes a discharge hole.

A shape of the film member is not particularly limited and may be appropriately selected depending on the intended purpose. Examples of the shape include a flat plate (film) shape. A plane shape of the film member is not particularly limited and may be appropriately selected depending on the intended purpose. Examples of the plane shape include an approximately perfect circular shape, an elliptic shape, and a polygonal shape. Among them, the plane shape of the film member is preferably an approximately perfect circular shape. Note that, the plane shape means a shape obtained when the film member is viewed in plane.

A size of the film member is not particularly limited and may be appropriately selected depending on the intended purpose. The size of the film member may be, for example, 20 mm in diameter (ϕ).

An average thickness of the film member is not particularly limited and may be appropriately selected depending on the intended purpose. The average thickness of the film member may be, for example, 0.05 mm.

A material of the film member is not particularly limited and may be appropriately selected depending on the intended purpose. Examples of the material include: metals such as stainless steel, nickel, and aluminum; plastics (resin materials) such as ABS, polycarbonate, and fluororesins; and ceramics such as silicon dioxide, alumina, and zirconia. Among them, stainless steel is preferable because a chromium oxide film that is a passive film can be easily formed on the surface by a chemical polishing treatment step using an acid/alkali treatment.

The material of the film member is preferably a material having a certain hardness. The material of the film member having a certain hardness is advantageous because the film member is not easily vibrated and can easily immediately suppress vibration when discharging is not performed.

Examples of the material having a certain hardness include metals, ceramics, and resin (polymer) materials. Among them, a material having low adhesiveness to cells or protein is preferably used when liquid to be discharged includes particles and when cells or protein is used as the particles.

It is said that adhesiveness of cells depends on a contact angle between a material and water. When a material has a high hydrophilicity or a high hydrophobicity, the adhesiveness of cells tends to be low.

Examples of the material having a high hydrophilicity include metals and ceramics (metal oxides). Examples of the material having a high hydrophobicity include fluororesins.

Examples of the metal include stainless steel, nickel, and aluminum.

Examples of the ceramic include silicon oxide, alumina, and zirconia.

The adhesiveness of cells is preferably decreased by coating the surface of the material of the film member (formation of the surface-treated film) Examples of the coating on the surface of the material of the film member include: coating on the surface of the material of the film member using the aforementioned metal or metal oxide material; coating using a synthetic phospholipid polymer shaped like a cell membrane (e.g., Lipidure available from NOF CORPORATION); and coating using an oxide containing Si.

A discharge surface of the film member is a surface side of the film member at which liquid is discharged. The discharge surface of the film member is a surface that is a under surface side of the liquid discharge head of the present disclosure.

### <<Discharge Hole>>

The discharge hole (nozzle) means a hole (aperture) that is configured to discharge liquid disposed on the film member. The discharge hole is formed as a through hole that penetrates, for example, between the upper surface and the under surface of the film member.

In the liquid discharge head of the present disclosure, an edge of the film member forming the discharge hole has a curve in a cross section of the film member in a thickness direction of the film member. The surface of the film member means a surface obtained when the film member is viewed in plane.

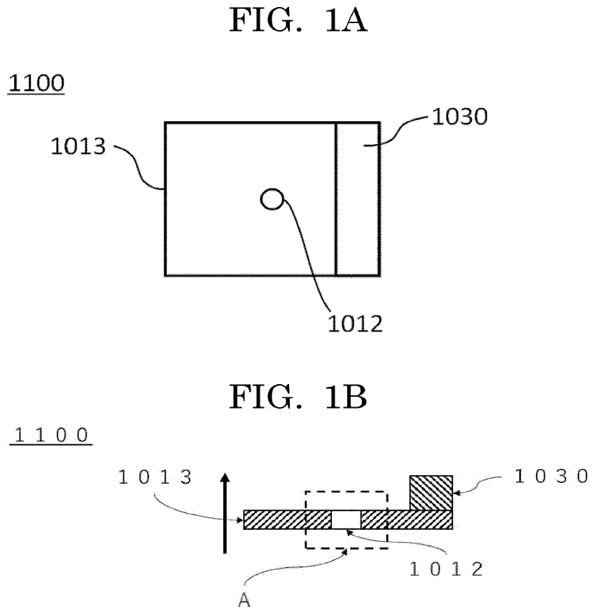

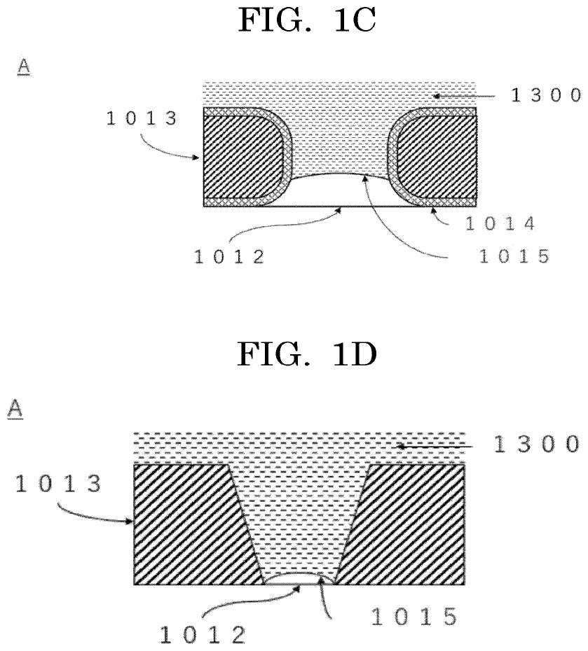

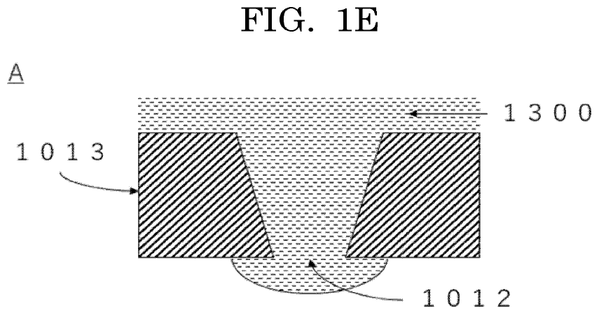

Here, cross-sectional shapes of the liquid discharge head of the present disclosure will be described by referring to FIG. 1A to FIG. 1C. As contrast, cross-sectional shapes of the conventional liquid discharge head will be described in FIG. 1D to FIG. 1E.

In each drawing, the same component may be denoted by the same reference numeral, and the redundant description may be omitted. The number, position, shape, and the like of the component are not limited to the embodiments of the present disclosure, and may be preferable number, position, shape, and the like of the component to perform the present disclosure.

The cross-sectional view in each drawing is a cross-sectional view of the liquid discharge head at a position including the discharge hole (nozzle) in a thickness direction of the film member (a normal direction to a surface forming the discharge hole).

FIG. 1A is a view presenting one example obtained when one example of the liquid discharge head of the present disclosure is viewed in plane. FIG. 1B is a view presenting one example of a cross section (a cross section of a thickness direction of the film member) obtained by cutting the liquid discharge head presented in FIG. 1A in a normal direction to a surface obtained by viewing one example of the liquid discharge head in plane. FIG. 1C is a view of one example where the discharge hole and the film member forming the discharge hole in the area surrounded by the dotted line in FIG. 1B are enlarged. FIG. 1D is a view presenting one example where the discharge hole and the film member forming the discharge hole in the area surrounded by the dotted line in FIG. 1B are enlarged in the conventional liquid discharge head. FIG. 1E is a view presenting another example where the discharge hole and the film member forming the discharge hole in the area surrounded by the dotted line in FIG. 1B are enlarged in the conventional liquid discharge head.

As presented in FIG. 1D and FIG. 1E, in a conventional liquid discharge head 1110, an edge of the film member forming the discharge hole does not have a curve in a cross section of the film member in a thickness direction of the film member, which is different from the liquid discharge head of the present disclosure. That is, a cross section of an edge of a film member 1013 forming a discharge hole 1012 does not have a curve, the cross section being in a normal direction to a surface forming the discharge hole 1012 (surface obtained by viewing the film member 1013 in plane). A meniscus 1015 of the liquid to be discharged is formed near the discharge surface of the discharge hole. In the case where the meniscus 1015 of the liquid to be discharged is formed near the discharge surface of the discharge hole, when formation of the meniscus 1015 is disturbed even a little, a liquid 1300 overflows from the discharge hole 1012, resulting in discharge defects.

Meanwhile, as presented in FIG. 1A and FIG. 1B, a liquid discharge head 1100 includes a film member 1013 and a displacement member 1030, and includes a discharge hole 1012 partially opened in the film member 1013. As presented in FIG. 1C, in the liquid discharge head of the present disclosure, an edge of the film member 1013 forming the discharge hole 1012 has a curve in a cross section of the film member 1013 in a thickness direction of the film member 1013. That is, a cross section of an edge of the film member 1013 forming the discharge hole 1012 has a curve, the cross section being in a normal direction to a surface forming the discharge hole 1012 (surface obtained by viewing the film member 1013 in plane). In other words, an edge of the film member 1013 forming the discharge hole 1012 as presented in FIG. 1C is subjected to round chamfering. When the film member 1013 forming the discharge hole 1012 has this shape, a position of the meniscus 1015 of the liquid to be discharged can be stabilized, and meniscus of liquid having a large surface tension can be particularly stabilized. Therefore, a liquid discharge head that can discharge various liquids stably and continuously can be achieved.

As presented in FIG. 1C, the liquid discharge head 1110 of the present disclosure includes a passive film 1014 on the surface of the film member 1013. When the surface of the film member includes the passive film, it is possible to prevent components of the liquid to be discharged from being deposited in and adhering to the surrounding of the discharge hole. Therefore, the position of the meniscus 1015 of the liquid to be discharged can be stabilized, and meniscus of liquid having a large surface tension can be particularly stabilized. Therefore, a liquid discharge head that can continuously discharge various liquids stably and continuously can be produced.

The number of arrays, an embodiment of the array, an interval (pitch), an opening shape, and a size of the opening of the discharge hole are not particularly limited and may be appropriately selected depending on the intended purpose.

The opening shape of the discharge hole is not particularly limited. Examples of the opening shape include a circular (perfect circular) shape, an elliptic shape, and a quadrangle.

An average diameter of the discharge hole is not particularly limited and may be appropriately selected depending on the intended purpose. When the liquid includes particles, the average diameter of the discharge hole is preferably twice or more the size of the particles in order to prevent the particles from being clogged in the discharge hole.

In the case where the particles are, for example, animal cells, particularly human cells, because a size of the human cells is 5 μm or more but 50 μm or less, an average diameter of the discharge hole is preferably 10 μm or more but 100 μm or less depending on cells to be used.

Meanwhile, the average diameter of the discharge hole is preferably 200 μm or less in order to prevent the liquid droplet from becoming too large and to facilitate formation of fine liquid droplets. Therefore, the average diameter of the discharge hole is more preferably 10 μm or more but 200 μm or less.

A position of the discharge hole in the film member is not particularly limited and may be appropriately selected depending on the intended purpose. The position may be a center of the film member when it is viewed in plane, and may be a position other than the center of the film member when it is viewed in plane.

Regarding a curve of a cross section of an edge of the film member forming the discharge hole in a cross section of the film member in a thickness direction of the film member, the curvature is not particularly limited and may be appropriately selected depending on the intended purpose. For example, the curvature is preferably 0.1 or more but 1 or less, more preferably 0.1 or more but 0.5 or less. When the curvature of the curve of the cross section of the edge of the film member forming the discharge hole in a normal direction to a surface forming the discharge hole is 0.1 or more but 1 or less, discharge defects caused by disturbed meniscus in discharging at a high frequency can be decreased, and straightness of the liquid droplet to be discharge can be improved.

A method for measuring a curvature of the curve of the edge of the film member forming the discharge hole in a cross section of the film member in a thickness direction of the film member is not particularly limited and may be appropriately selected depending on the intended purpose. For example, any point of the film member is regarded as a center, and a radius of an arc including 10% or more of a side in the cross section of the edge of the film member forming the discharge hole is measured. Then, a reciprocal of the measured radius of the arc is calculated to determine the curvature.

Note that, the edge of the film member forming the discharge hole means a portion of the film member that forms a circumference of the discharge hole.

A method for processing the film member so that the edge of the film member forming the discharge hole has a curve in a cross section of the film member in a thickness direction of the film member is not particularly limited and may be appropriately selected depending on the intended purpose. Examples of the method include: a method where the film member is immersed in a heated chemical liquid under stirring when the below-described passive film is formed on the film member; and a method where the edge of the film member is molded so as to have a desired curvature by press processing after the discharge hole is formed.

In the case of a method using the chemical liquid, the curvature of the curve of the edge of the film member forming the discharge hole in a cross section of the film member in a thickness direction of the film member can be appropriately adjusted by changing conditions for processing the film member (e.g., kinds of chemical liquids, temperature, and treatment time).

The chemical liquid is not particularly limited and may be appropriately selected depending on a film member to be used. Examples of the chemical liquid include chemical liquids using, for example, S-CLEAN S-250 (SASAKI CHEMICAL CO., LTD.).

The temperature is not particularly limited and may be appropriately selected depending on a film member to be used.

The treatment time is not particularly limited and may be appropriately selected depending on the intended purpose.

In a molding method through the press processing, the curvature can be controlled by appropriately controlling a curvature of a mold to be used for a press. In this case, the passive film is not formed. Therefore, when the passive film is required, the passive film can be formed by performing a method for forming the passive film that will be described hereinafter.

A surface roughness (Ra) of the film member forming the discharge hole is not particularly limited and may be appropriately selected depending on the intended purpose. For example, the surface roughness (Ra) is preferably 100 nm or less, more preferably 0 nm or more but 80 nm or less, still more preferably 0 nm or more but 50 nm or less. When the surface roughness (Ra) of the film member forming the discharge hole is 100 nm or less, an effect of preventing liquid components from being deposited on the discharge hole can be improved.

A method for measuring the surface roughness (Ra) of the film member forming the discharge hole is not particularly limited and may be appropriately selected depending on the intended purpose. The surface roughness (Ra) can be measured according to, for example, ISO 1302 (JIS B 0031). An apparatus for measuring the surface roughness is not particularly limited and may be appropriately selected depending on the intended purpose. The surface roughness can be measured using, for example, VR3200 (available from KEYENCE CORPORATION). As the surface roughness (Ra), an average value obtained from 5 or more measurements by the measurement method is preferably used.

The passive film means a chemically stable film, and means, for example, a film containing a metal species that forms a passive state. The passive film is preferably an oxide film of a metal that forms the passive state. The metal contained in the passive film is not particularly limited and may be appropriately selected depending on the intended purpose. The metal may be used alone or two or more metals may be used. Preferable examples of the metal include metal elements of group 4, group 5, group 6, group 13, and group 15. Aluminum, bismuth, antimony, tantalum, niobium, titanium, hafnium, and tungsten are more preferable.

As the passive film, a chromium oxide film, a zirconium oxide film, and a tantalum oxide film are preferable.

A position of the passive film on the film member is not particularly limited and may be appropriately selected depending on the intended purpose. For example, the passive film may be positioned on the whole surface of the film member, or may be positioned at least on the surface of the film member constituting the periphery of the discharge hole.

By using these passive films, wettability to the liquid is secured and the components contained in the liquid can be prevented from adhering to the periphery of the discharge hole.

A method for forming the passive film is not particularly limited and may be appropriately selected depending on the intended purpose. Examples of the method include a chemical polishing treatment.

### <<<Liquid>>>

The liquid discharged from the discharge hole is not particularly limited and may be appropriately selected depending on the intended purpose. Examples of the liquid include various organic solvents such as ion exchanged water, distilled water, pure water, physiological saline solution, alcohols, mineral oil, and vegetable oil. The liquid discharged from the discharge hole preferably includes particles.

When water is used as the liquid discharged from the discharge hole, the liquid preferably includes a wetting agent in order to prevent evaporation of moisture. In these formulations, general materials used for inkjet inks can be used.

The liquid discharged from the discharge hole is preferably discharged as a liquid droplet from the discharge hole.

The diameter of a liquid droplet is not particularly limited and may be appropriately selected depending on the intended purpose, and is preferably 25 μm or greater but 150 μm or less. When the diameter of a liquid droplet is 25 μm or greater, a particle to be contained in the liquid droplet has an appropriate diameter, making it possible to use many kinds of particles. When the diameter of a liquid droplet is 150 μm or less, discharging of the liquid droplet is stable.

When it is assumed that the diameter of a liquid droplet is R and the diameter of a particle that will be described hereinafter is r, it is preferable that R>3r be satisfied. When R>3r is satisfied, the relationship between the diameter of a particle that will be described hereinafter and the diameter of a liquid droplet is appropriate, and a particle is not to be influenced by the edge (outline) of the liquid droplet. Therefore, when the number of the particles contained in the liquid droplet is counted by the below-described liquid discharge apparatus, the counting accuracy of the particle can be improved.

A liquid amount in a liquid droplet is not particularly limited, and may be appropriately selected depending on the intended purpose. The liquid amount is preferably 1,000 pL or lower, more preferably 100 pL or lower.

The liquid amount in a liquid droplet can be measured by, for example, a method where the size of a liquid droplet is determined based on a liquid droplet image, followed by calculating the liquid amount.

The number of the particles contained in the liquid droplet is not particularly limited and may be appropriately selected depending on the intended purpose. For example, the number of the particles is preferably 1 or more, more preferably 1 or more but 5 or less.

Examples of the particles contained in the liquid or the liquid droplet include cells, metallic particle, and inorganic particles. Among them, cells are preferable.

### -Cells-

Cells are not particularly limited and may be appropriately selected depending on the intended purpose. All kinds of cells can be used regardless of whether the cells are eukaryotic cells, prokaryotic cells, multicellular organism cells, and unicellular organism cells. These may be used alone or in combination.

The eukaryotic cells are not particularly limited and may be appropriately selected depending on the intended purpose. Examples of the eukaryotic cells include animal cells, insect cells, plant cells, fungi, algae, and protozoans. These may be used alone or in combination. Among them, animal cells and fungi are preferable, and cells derived from humans are more preferable.

Adherent cells may be primary cells directly taken from tissues or organs, or may be cells obtained by passaging primary cells directly taken from tissues or organs a few times. Adherent cells may be appropriately selected depending on the intended purpose. Examples of adherent cells include differentiated cells and undifferentiated cells.

Differentiated cells are not particularly limited and may be appropriately selected depending on the intended purpose. Examples of differentiated cells include: hepatocytes, which are parenchymal cells of a liver; stellate cells; Kupffer cells; endothelial cells such as vascular endothelial cells, sinusoidal endothelial cells, and corneal endothelial cells; fibroblasts; osteoblasts; osteoclasts; periodontal ligament-derived cells; epidermal cells such as epidermal keratinocytes; epithelial cells such as tracheal epithelial cells, intestinal epithelial cells, cervical epithelial cells, and corneal epithelial cells; mammary glandular cells; pericytes; muscle cells such as smooth muscle cells and myocardial cells; renal cells; islets of Langerhans cells; nerve cells such as peripheral nerve cells and optic nerve cells; chondrocytes; and bone cells.

Undifferentiated cells are not particularly limited and may be appropriately selected depending on the intended purpose. Examples of undifferentiated cells include: pluripotent stem cells such as embryotic stem cells, which are undifferentiated cells, and mesenchymal stem cells having pluripotency; unipotent stem cells such as vascular endothelial progenitor cells having unipotency; and iPS cells.

Fungi are not particularly limited and may be appropriately selected depending on the intended purpose. Examples of the fungi include molds and yeast fungi. These may be used alone or in combination. Among them, yeast fungi are preferable because the cell cycles are adjustable and monoploids can be used.

The cell cycle means a cell proliferation process in which cells undergo cell division and cells (daughter cells) generated by the cell division become cells (mother cells) that undergo another cell division to generate new daughter cells.

Yeast fungi are not particularly limited and may be appropriately selected depending on the intended purpose. For example, Bar1-deficient yeasts with enhanced sensitivity to a pheromone (sex hormone) that controls the cell cycle at a G1 phase are preferable. When yeast fungi are Bar1-deficient yeasts, the abundance ratio of yeast fungi with uncontrolled cell cycles can be reduced. Therefore, for example, an increase in the number of a specific nucleic acid of the cells contained in a liquid chamber can be prevented.

The prokaryotic cells are not particularly limited and may be appropriately selected depending on the intended purpose. Examples of the prokaryotic cells include eubacteria and archaea. These may be used alone or in combination.

As the cells, living cells are preferable.

As the cells, cells that can emit light upon reception of light are preferable. With cells that can emit light upon reception of light, it is possible to land the cells on a target to be landed while having a highly accurate control on the number of cells by an optical sensor.

Here, reception of light means receiving of light.

An optical sensor means a passive sensor configured to collect, with a lens, any light in the range from visible light rays visible by human eyes to near infrared rays, short-wavelength infrared rays, and thermal infrared rays that have longer wavelengths than the visible light rays, to obtain, for example, shapes of target cells in the form of image data.

--Cells that can Emit Light Upon Reception of Light--

The cells that can emit light upon reception of light are not particularly limited and may be appropriately selected depending on the intended purpose so long as the cells can emit light upon reception of light. Examples of the cells include cells stained with a fluorescent dye, cells expressing a fluorescent protein, and cells labeled with a fluorescent-labeled antibody.

A site stained with a fluorescent dye, an expression site of a fluorescent protein, or a labeled site with a fluorescent-labeled antibody in the cells is not particularly limited. Examples thereof include a whole cell, a cell nucleus, and a cellular membrane.

---Fluorescent Dye---

Examples of the fluorescent dye include fluoresceins, azo dyes, rhodamines, coumarins, pyrenes, and cyanines. These may be used alone or in combination. Among them, fluoresceins, azo dyes, and rhodamines are preferable, and eosin, Evans blue, trypan blue, rhodamine 6G, rhodamine B, and rhodamine 123 are more preferable.

As the fluorescent dye, a commercially available product may be used. Examples of the commercially available product include product name: EOSIN Y (available from Wako Pure Chemical Industries, Ltd.), product name: EVANS BLUE (available from Wako Pure Chemical Industries, Ltd.), product name: TRYPAN BLUE (available from Wako Pure Chemical Industries, Ltd.), product name: RHODAMINE 6G (available from Wako Pure Chemical Industries, Ltd.), product name: RHODAMINE B (available from Wako Pure Chemical Industries, Ltd.), and product name: RHODAMINE 123 (available from Wako Pure Chemical Industries, Ltd.).

### ---Fluorescent Protein---

Examples of the fluorescent protein include Sirius, EBFP, ECFP, mTurquoise, TagCFP, AmCyan, mTFP1, MidoriishiCyan, CFP, TurboGFP, AcGFP, TagGFP, Azami-Green, ZsGreen, EmGFP, EGFP, GFP2, HyPer, TagYFP, EYFP, Venus, YFP, PhiYFP, PhiYFP-m, TurboYFP, ZsYellow, mBanana, KusabiraOrange, mOrange, TurboRFP, DsRed-Express, DsRed2, TagRFP, DsRed-Monomer, AsRed2, mStrawberry, TurboFP602, mRFP1, JRed, KillerRed, mCherry, mPlum, PS-CFP, Dendra2, Kaede, EosFP, and KikumeGR. These may be used alone or in combination.

### ---Fluorescent-Labeled Antibody---

The fluorescent-labeled antibody is not particularly limited and may be appropriately selected depending on the intended purpose so long as the fluorescent-labeled antibody is fluorescent-labeled. Examples of the fluorescent-labeled antibody include CD4-FITC and CD8-PE. These may be used alone or in combination.

It is preferable that the cells include a specific nucleic acid. The cell number of cells including a specific nucleic acid is not particularly limited and may be appropriately selected depending on the intended purpose so long as the cell number is a plural number.

### ---Specific Nucleic Acid---

The specific nucleic acid is not particularly limited and may be appropriately selected depending on the intended purpose. Examples of the specific nucleic acid include base sequences used for infectious disease testing, naturally non-existent nucleic acids, animal cell-derived base sequences, and plant cell-derived base sequences. These may be used alone or in combination. As the specific nucleic acid, a plasmid can also be suitably used.

A nucleic acid means a polymeric organic compound in which a nitrogen-containing base derived from purine or pyrimidine, sugar, and phosphoric acid are bonded with one another regularly.

The specific nucleic acid is not particularly limited and may be appropriately selected depending on the intended purpose. Examples of the specific nucleic acid include DNA and RNA. Among them, for example, DNA corresponding to RNA derived from a fixed area of an infectious disease such as norovirus and naturally non-existent DNA can be suitably used.

The specific nucleic acid included in a plurality of cells may be a specific nucleic acid derived from the cells to be used, or a specific nucleic acid introduced by transgenesis. When a specific nucleic acid introduced by transgenesis and a plasmid are used as the specific nucleic acid, it is preferable to confirm that one copy of the specific nucleic acid is introduced per cell. The method for confirming that one copy of the specific nucleic acid is introduced is not particularly limited and may be appropriately selected depending on the intended purpose. Examples of the method include a sequencer, a PCR method, and a Southern blotting method.

The method for transgenesis is not particularly limited and may be appropriately selected depending on the intended purpose so long as the method can introduce an intended number of specific nucleic acid sequence molecules at an intended position. Examples of the method include homologous recombination, CRISPR/Cas9, TALEN, Zinc finger nuclease, Flip-in, and Jump-in. Particularly, in the case of yeast fungi, homologous recombination is preferable in terms of a high efficiency and ease of controlling.

### -Metallic Particles-

The metallic particles are not particularly limited and may be appropriately selected depending on the intended purpose. Examples of the metallic particles include silver particles and copper particles. These metallic particles can be used for drawing wiring with liquid droplets discharged.

### -Inorganic Particles-

The inorganic particles are not particularly limited and may be appropriately selected depending on the intended purpose. For example, titanium oxide and silicon oxide are used as white inks or for spacer material coating.

When aggregation of particles occurs, adjustment of the concentration of particles in the particle-containing liquid enables appropriate adjustment of the number of particles in the liquid, based on the theory where the concentration of particles in a liquid and the number of particles in a liquid conform to a Poisson distribution.

### <Displacement Member>

The displacement member (displacement section) is configured to displace a position of the film member to discharge liquid from the discharge hole.

An aspect of the displacement member is not particularly limited and may be appropriately selected depending on the intended purpose. Examples of the aspect include: an aspect (first aspect) where the displacement member is positioned at a side at which the liquid discharged from the discharge hole is disposed in the film member, and a position of the film member is displaced to discharge the liquid from the discharge hole; an aspect (second aspect) where the displacement member is connected to at least part of the peripheral part of the film member, and a position of the film member is displaced to discharge the liquid from the discharge hole; an aspect (third aspect) where a position of the film member is displaced to discharge the liquid from the discharge hole; and an aspect (fourth aspect) where the displacement member is positioned at a side opposite to a side at which liquid is discharged from the discharge hole in the below-described liquid stored section, and a position of the below-described liquid stored section is displaced to discharge the liquid from the discharge hole.

In a conventional liquid discharge head, a film member (nozzle plate) forming a nozzle section is vibrated to form a liquid droplet. Specifically, in the conventional liquid discharge unit, when a piezoelectric element disposed in the film member greatly vibrates (deforms) the vicinity of the nozzle section of the film member, the liquid droplet is formed and discharged. Therefore, in the conventional liquid discharge head, the film member needs to have a certain length.

In the liquid discharge head of the present disclosure, when the displacement member displaces a position of the film member or the below-described liquid stored section, liquid disposed in the film member or the below-described liquid stored section can be given inertial force to discharge, from the discharge hole, the liquid disposed in the film member or the below-described liquid stored section. That is, as a position of the film member or the below-described liquid stored section is displaced, a position of the discharge hole is displaced, to increase a pressure applied to the liquid to be discharged. Then, the liquid discharge head of the present disclosure discharges a liquid droplet from the discharge hole.

In addition, the liquid discharge head of the present disclosure may perform preliminary discharging to stably discharge the liquid by displacing the position of the below-described liquid stored section by the displacement member. Moreover, in the liquid discharge head, the liquid stored in the below-described liquid storage chamber may be stirred by displacing the position of the film member by the displacement member.

Note that, when the liquid discharge head includes a connection member that will be described hereinafter, the displacement member preferably displaces positions of the film member, the liquid stored section, and the connection member.

Here, the film member or the below-described liquid stored section may be referred to as “film member etc.”

A direction in which the displacement member displaces a position of the film member etc. is not particularly limited and may be appropriately selected depending on the intended purpose. When the liquid discharge head discharges the liquid, the position of the film member is preferably displaced in a direction of the liquid to be discharged. The direction of the liquid to be discharged is preferably an approximate gravity direction.

When the displacement member displaces the position of the film member etc., the film member is preferably reciprocated (reciprocating motion), and is more preferably vibrated.

In the liquid discharge head of the present disclosure, the displacement member preferably reciprocates the film member etc. in an approximately parallel direction to a direction in which the liquid is discharged from the discharge hole, to displace the position of the film member etc. This makes it possible to more efficiently discharge the liquid and to accurately discharge the liquid at a desired position in the liquid discharge head of the present disclosure.

When the position of the film member etc. is displaced to discharge the liquid from the discharge hole, the whole position of the film member etc. may be displaced, or the film member etc. may be deformed to displace the position of the discharge hole in the film member etc. In other words, in the present disclosure, the displacement member may displace the whole position of the film member etc. to discharge the liquid, or the displacement member may deform the film member etc. to displace the position of the discharge hole of the film member etc. for discharging the liquid.

A shape, a size, a material, and a structure of the displacement member are not particularly limited and may be appropriately selected depending on the intended purpose.

As the displacement member, a piezoelectric element is suitably used.

The piezoelectric material is not particularly limited and may be appropriately selected depending on the intended purpose. Examples of the piezoelectric material include lead zirconate titanate (PZT), bismuth iron oxide, metal niobate, barium titanate, and materials obtained by adding metals or different oxides to these materials. Among them, lead zirconate titanate (PZT) is preferable because a high reverse voltage effect can be obtained.

A vibration mode in the piezoelectric element is not particularly limited and may be appropriately selected depending on the intended purpose. Examples of the vibration mode include a longitudinal mode and a shear mode.

As the piezoelectric element of the longitudinal mode, for example, it is possible to use a laminated-type piezoelectric element where the piezoelectric element is stretched in a longitudinal direction and is shrunk in a transverse direction by application of voltage. As the piezoelectric element of the shear mode, it is possible to use a bimorph-type (bend-type) piezoelectric element where the piezoelectric element is deformed and bent by application of voltage to displace a position of one end of the piezoelectric element.

The displacement member may displace the position of the discharge hole by attaching, on the film member, a material having a coefficient of linear expansion different from that of the film member, followed by heating. In this case, a heater may be disposed near the material having a different coefficient of linear expansion, and the heater may be heated through electrification to displace the position of the discharge hole.

The position at which the displacement member is displaced is not particularly limited and may be appropriately selected depending on the first aspect to the fourth aspect.

The displacement member preferably abuts on the film member. When the displacement member abuts on the film member, the liquid can be discharged by, for example, at least the film member and the displacement member. Therefore, the liquid discharge head can have a simpler structure.

The position at which the displacement member abuts on the film member is not particularly limited and may be appropriately selected depending on the intended purpose, so long as the position is a position at which the displacement member can displace the position of the film member to discharge the liquid.

Preferably, the displacement member is positioned so as to surround the peripheral part of the film member, and the liquid disposed in the film member can be retained. As a result, the displacement member can retain the liquid to be discharged from the discharge hole, and more liquid can be disposed on the film member. When the displacement member can retain the liquid, the liquid discharge head can retain the liquid with a predetermined thickness on the film member. Therefore, when the liquid is discharged from the discharge hole, the hydraulic pressure of the liquid on the film member can be stabilized, and thus the liquid can be more stably discharged.

As the peripheral part of the film member, a region near an edge of the outer side (side far from the discharge hole) in the film member can be selected. When the displacement member is positioned so as to surround the peripheral part of the film member, more liquid can be retained.

When the displacement member is positioned (disposed) so as to surround the peripheral part of the film member, a plane shape of the film member may be, for example, an annular (ring) shape and the same shape as a shape of the peripheral part of the film member.

At least part of the surface of the displacement member preferably includes a coating film that blocks contact with the liquid. More specifically, for example, when the part of the surface of the displacement member is in such a positional relationship that it contacts with the liquid discharged from the discharge hole, a part of the displacement member that can contact with the liquid is preferably provided with the coating film that blocks contact with the liquid.

This makes it possible to prevent the displacement member from contacting with the liquid, and to prevent defects caused by contacting the displacement member with the liquid even when the displacement member having no durability to the liquid discharged from the discharge hole is used.

The coating film preferably has such a material or thickness that does not block motion of the displacement member. For example, the coating film may have water resistance when the liquid discharged from the discharge hole is liquid mainly including water.

The coating film is not particularly limited and may be appropriately selected depending on the intended purpose, so long as it can block contact with the liquid discharged from the discharge hole. Examples of the coating film include: organic film such as parylene, epoxy, and melamine; and inorganic films.

A method for forming the coating film on the surface of the displacement member is not particularly limited and may be appropriately selected depending on the intended purpose. Examples of the method include spin coating, dip coating, spray coating, vapor deposition, and CVD.

When the liquid discharge head of the present disclosure includes a film member including a discharge hole configured to discharge liquid, and a displacement member configured to displace a position of the film member to discharge the liquid from the discharge hole, the displacement member displaces the position of the film member to discharge the liquid from the discharge hole. Therefore, unlike the aforementioned conventional liquid discharge head, it is not necessary to greatly vibrate (deform) the vicinity of the discharge hole of the film member, and the whole position of the film member can be displaced to discharge the liquid. That is, in the liquid discharge head of the present disclosure, as a position of the film member is displaced, a position of the discharge hole is displaced, to increase a pressure applied to the liquid to be discharged. Then, a liquid droplet is discharged from the discharge hole. Therefore, in the liquid discharge head of the present disclosure, deformation of the film member is not essential, and thus the liquid discharge head of the present disclosure can have a simple structure and can use a film member smaller (shorter) than that of the conventional liquid discharge head. Therefore, the liquid discharge head of the present disclosure can be miniaturized compared to the conventional liquid discharge heads.

Moreover, because the liquid discharge head of the present disclosure can be miniaturized compared to the conventional liquid discharge heads, many liquid discharge heads can be disposed in one liquid discharge apparatus. Therefore, when a cell solution (cell suspension) is discharged to form a tissue formed of a plurality of cells, the liquid discharge apparatus including the liquid discharge head of the present disclosure can form the tissue in a shorter time, and a survival rate of the cells at the time of formation can be prevented from being decreased.

As described above, the liquid discharge head of the present disclosure displaces the whole position of the film member including the nozzle or the liquid stored section, to discharge the liquid. Therefore, the liquid discharge head of the present disclosure can stir the liquid stored in the film member or the liquid stored section by displacing the position of the film member or the liquid stored section, or by displacing the position of the film member or the liquid stored section to a degree that the liquid is not discharged.

As described above, the liquid discharge unit of the present disclosure can discharge and stir the liquid and can be further miniaturized without limiting a size of the film member (nozzle plate) or the displacement member.

In the liquid discharge head of the present disclosure, because the film member is not deformed when the liquid is discharged, a film member having a high rigidity can be applied. Therefore, it is possible to improve durability when the liquid in the liquid discharge head is continuously discharged, and to prevent damages on the film member caused when a side at which the liquid in the film member is discharged (under surface side of the film member) is cleaned using a cleaning device such as brush. In other words, the liquid discharge head of the present disclosure can have a simple structure and a high durability because the film member having a high rigidity can be applied thereto. Therefore, the liquid discharge head of the present disclosure can be improved in maintainability compared to the conventional liquid discharge heads.

### <Fixing Member>

The liquid discharge head of the present disclosure preferably includes a fixing member (fixing section) configured to fix a side opposite to a side at which the displacement member abuts on the film member. When the liquid discharge head includes the fixing member, a degree of freedom to select a position of the liquid discharge head disposed can be improved. For example, it can be easier to arrange and dispose many liquid discharge heads.

Here, a shape, a size, a material, and a structure of the fixing member are not particularly limited and may be appropriately selected depending on the intended purpose, so long as the side opposite to the side at which the displacement member abuts on the film member can be fixed.

The fixing member is preferably formed of a material having a high rigidity and is less deformed. Examples of the material having a high rigidity and is less deformed that can be applied to the fixing member include metal materials such as stainless steel (SUS) and ceramic materials.

When the fixing member is formed of the material having a high rigidity and is less deformed, energy loss of the displacement of the displacement member can be suppressed, the position of the film member can be efficiently displaced, and the liquid can be efficiently discharged from the discharge hole.

### <Liquid Stored Section>

The liquid stored section includes a nozzle. Preferably, at least part of the liquid stored section can allow gas pass therethrough. The phrase “at least part of the liquid stored section can allow gas pass therethrough” means that gas can pass between the inside and the outside of the liquid storage chamber of the liquid stored section.

The liquid stored section is not particularly limited and may be appropriately selected depending on the intended purpose. The liquid stored section includes a liquid storage chamber and a nozzle (liquid discharge hole), preferably further includes an air vent, more preferably further includes at least one of an opening section and an adhesion preventing section.

### <<Liquid Storage Chamber>>

The liquid discharge head of the present disclosure preferably includes a liquid storage chamber (liquid chamber) that can store liquid in at least one of the film member and the liquid stored section.

When the liquid discharge head includes the liquid storage chamber, liquid to be discharged from the discharge hole can be stored and more liquid can be disposed on the film member. As a result of this, the liquid discharge head can store the liquid with a predetermined thickness on the film member, and the hydraulic pressure of the liquid on the film member can be stabilized when the liquid is discharged from the discharge hole. Therefore, the liquid can be more stably discharged. Moreover, when the liquid discharge head includes the liquid storage chamber, a larger amount of the liquid can be disposed on the film member. Therefore, the number of supplying the liquid to the liquid discharge head can be decreased, and more liquid droplets can be discharged in a shorter time. Particularly, when the cell solution (cell suspension) is discharged from the liquid discharge head to form a tissue formed of a plurality of cells, the tissue can be formed in a shorter time, and therefore a survival rate of the cells at the time of formation can be prevented from being decreased.

A shape, a size, a material, and a structure of the liquid storage chamber are not particularly limited and may be appropriately selected depending on the intended purpose, so long as the liquid disposed on at least one of the film member and the displacement member can be stored.

The liquid storage chamber may be, for example, an article obtained by allowing a cylindrical member (liquid chamber) to adhere onto the displacement member that abuts on the film member.

Preferably, at least part of the liquid storage chamber can allow gas pass therethrough. The phrase “at least part of the liquid storage chamber can allow gas pass therethrough” means that gas can pass between the inside and the outside of the liquid chamber of the liquid storage chamber.

The liquid storage chamber is not particularly limited and may be appropriately selected depending in the intended purpose. The liquid storage chamber preferably further includes an air vent, more preferably further includes at least one of an opening section and an adhesion preventing section.

### <<<Liquid Chamber>>>

The liquid chamber is configured to store the liquid.

A shape, a size, a material, and a structure of the liquid chamber are not particularly limited and may be appropriately selected depending on the intended purpose.

Examples of the material of the liquid chamber include: metals such as stainless steel, nickel, and aluminum; plastics (resin materials) such as ABS, polycarbonate, and fluororesins; and ceramics such as silicon dioxide, alumina, and zirconia. Among them, even when the liquid stored in the liquid chamber includes particles, and cells or protein is used as the particles, a material having a low adhesiveness to the cells or the protein is preferably used.

It is said that adhesiveness of cells depends on a contact angle between a material and water. When a material has a high hydrophilicity or a high hydrophobicity, the adhesiveness of cells tends to be low. Examples of the material having a high hydrophilicity include various metal materials and ceramics (metal oxides). Examples of the material having a high hydrophobicity include fluororesins.

The adhesiveness of cells is preferably decreased by coating the surface of the material of the liquid chamber. Examples of the coating the surface of the material of the liquid chamber include: coating the surface of the material with the aforementioned metal or metal oxide material; coating through sputtering; formation of the passive film on the surface by a chemical polishing treatment; and coating using a synthetic phospholipid polymer shaped like a cell membrane (e.g., Lipidure available from NOF CORPORATION).

### <<Air Vent>>

The air vent (atmosphere open section) means a hole (aperture) that can allow gas pass between the inside and the outside of the liquid storage chamber. When the liquid storage chamber includes the air vent, an atmospheric pressure inside the liquid storage chamber is substantially the same as an atmospheric pressure outside the liquid storage chamber (generally, atmospheric pressure). Therefore, the inside of the liquid storage chamber can be prevented from becoming a negative pressure, and the liquid stored in the liquid storage chamber can be stably discharged.

The air vent is not particularly limited and may be appropriately selected depending on the intended purpose, so long as it can allow gas pass between the inside and the outside of the liquid storage chamber.

The air vent may be, for example, an aperture penetrating the liquid storage chamber, and an opening section for ventilation obtained by opening a part of the liquid storage chamber. The air vent may be covered with a member that can allow gas pass therethrough. Examples of the member that can allow gas pass therethrough include mesh-shaped members and sponge-shaped members.

When gas can pass between the inside and the outside of the liquid storage chamber, the inside of the liquid storage chamber can be prevented from becoming a negative pressure when the liquid is discharged, and the liquid can be easily discharged. In addition, this makes it possible to discharge bubbles included in the liquid stored in the liquid storage chamber, and therefore the liquid can be stably discharged.

In the case where gas can pass between the inside and the outside of the liquid storage chamber, when the liquid stored in the liquid storage chamber includes cells as the particles, it is possible to prevent damages to the cells caused by application of pressure at the time of discharging the liquid. In the case where damages to the cells caused by application of pressure at the time of discharging the liquid can be prevented, when a tissue formed of a plurality of cells is formed, a survival rate of the cells can be prevented from being decreased, which is advantageous.

### <<Opening Section>>

The liquid storage chamber preferably includes an opening section.

The opening section is not particularly limited and may be appropriately selected depending on the intended purpose. The opening section is preferably an opening section configured to expose at least part of the liquid stored in the liquid storage chamber to the outside of the liquid storage chamber. The opening section may be an embodiment where the aforementioned air vent functions as the opening section (the opening section and the air vent are the same), or may be an embodiment where the opening section is provided in addition to the air vent. One example of the embodiment where the opening section is provided in addition to the aforementioned air vent is, for example, an embodiment where the opening section is provided in an adhesion preventing section that will be described hereinafter.

When the liquid storage chamber includes the opening section, operation of the liquid stored in the liquid storage chamber can be performed without removing the liquid storage chamber from a supporting member that will be described hereinafter.

When operation of the liquid stored in the liquid storage chamber can be performed without removing the liquid storage chamber from a supporting member that will be described hereinafter, time required for operation of the liquid can be shortened. As a result, efficiency of discharging the liquid droplet can be improved. In the case where the efficiency of discharging the liquid droplet can be improved, when a tissue formed of a plurality of cells is formed, a survival rate of the cells can be prevented from being decreased, which is advantageous.

Examples of the operation of the liquid include supplement of the liquid and stirring of the liquid, which can be performed by an operation tool. Examples of the operation tool include: pipettes such as a Komagome pipette, a transfer pipette, a measuring pipet, and a micropipette; glass tubes; and glass rods.

A position at which the opening section is provided is preferably a position at which the operation tool can be easily inserted into the opening section and operation of the operation tool is not limited by a connection member that will be described hereinafter or the displacement member.

### <<Adhesion Preventing Section>>

The liquid storage chamber preferably includes an adhesion preventing section configured to prevent the liquid stored in the liquid storage chamber from being attached to the outside of the liquid storage chamber.

The adhesion preventing section is not particularly limited and may be appropriately selected depending on the intended purpose. Examples of the adhesion preventing section include: a lid-type form that covers at least part of the upper part of the liquid storage chamber (so that gas can pass); and a hood (canopy)-type form that is partially opened.

When the liquid storage chamber includes the adhesion preventing section, it is possible to prevent cause of contamination. The contamination is caused by scattering the liquid outside the liquid storage chamber when the liquid storage chamber is displaced (vibrated) at the time of discharging the liquid, followed by attaching the liquid to a member other than the liquid storage chamber.

As described above, an embodiment where the adhesion preventing section includes the opening section is preferable. When the adhesion preventing section includes the opening section, it is possible to prevent contamination which is caused by bringing the operation tool in contact with a member other than the operation tool to attach the liquid thereto when operation of the liquid stored in the liquid storage chamber is performed.

### <Electrodes>

When a piezoelectric element is used as the displacement member, for example, a structure where electrodes configured to apply voltage to a piezoelectric material are provided is preferable. In this case, when voltage is applied between electrodes of the piezoelectric element from a driving unit, the piezoelectric element can be vibrated to vibrate the film member.

A position at which the electrodes configured to apply voltage to the displacement member are provided is preferably a position at which the electrodes are not in contact with the liquid discharged from the discharge hole. Moreover, as the position at which the electrodes are provided, the electrodes are preferably provided outside the liquid storage chamber when the liquid discharge head includes the liquid storage chamber. In other words, when the liquid discharge head includes the liquid storage chamber, it is preferable to include the electrodes configured to apply voltage to the displacement member outside the liquid storage chamber. As a result, the liquid discharge head can prevent the liquid discharged from the discharge hole and the electrodes from contacting with each other, and to prevent defects caused when the liquid discharged from the discharge hole contacts with the electrodes.

### <<Lid Member>>

The liquid discharge head of the present disclosure preferably includes a lid member disposed so as to face the film member at a side of the film member at which the liquid is disposed. Therefore, the liquid discharge head of the present disclosure makes it possible to decrease an amount of the stored liquid volatilized. Moreover, the lid member preferably includes the air vent. The adhesion preventing section may function as the lid member.

A shape, a size, a material, and a structure of the lid member are not particularly limited and may be appropriately selected depending on the intended purpose.

The liquid discharge head of the present disclosure preferably further includes a stirring section that is mounted on the lid member and is configured to transfer the stored liquid to stir the liquid. Therefore, in the case where the liquid includes particles, even when the particles in the stored liquid are precipitated to easily cause clogging of the discharge hole with the particles at the time of discharging, the liquid discharge head of the present disclosure can disperse the particles.

The stirring section (stirring unit) is not particularly limited and may be appropriately selected depending on the intended purpose, so long as the liquid can be stirred. Examples of the stirring section (stirring unit) include those including a first liquid feeding unit, a second liquid feeding unit, a flow pass that connects the first liquid feeding unit to a liquid retaining section, and a flow pass that connects the second liquid feeding unit and the liquid retaining section. In this case, a flow pass provided with a water shut-off valve can be preferably used. At this time, preferably, the first liquid feeding unit and the second liquid feeding unit function as a pair of liquid transferring sections, and the flow pass and the flow pass function as a pair of liquid storing sections, and the water shut-off valve and the water shut-off valve function as a pair of opening and shutting sections.

In the liquid discharge head of the present disclosure, the stirring section preferably supplies the liquid discharged from the discharge hole. As a result, the liquid discharge head of the present disclosure can rapidly supply the liquid even when discharging the liquid is repeated to decrease an amount of the stored liquid.

### <Support (Connection) Member>

The liquid discharge head of the present disclosure preferably includes a support (connection) member that connects the liquid storage chamber to the displacement member.

The supporting member supports the liquid stored section.

The liquid discharge head of the present disclosure preferably includes: the liquid storage chamber that can store the liquid disposed on at least one of the film member and the displacement member; and the support (connection) member that connects the liquid storage chamber to the displacement member. When the liquid discharge head of the present disclosure includes the support (connection) member, a degree of freedom to select a shape or disposition of the liquid discharge head can be further improved. For example, it can be easier to arrange and dispose many liquid discharge heads.

A shape, a size, a material, and a structure of the support (connection) member are not particularly limited and may be appropriately selected depending on the intended purpose.

Examples of the material of the support (connection) member include: metals such as stainless steel, nickel, and aluminum; plastics such as ABS, polycarbonate, and fluororesins; and ceramics such as silicon dioxide, alumina, and zirconia.

A method for connecting (supporting) the liquid storage chamber by the support (connection) member is not particularly limited and may be appropriately selected depending on the intended purpose. Examples of the method include: a method for supporting the liquid storage chamber so that at least part of the air vent of the liquid storage chamber is opened; and a method for connecting (supporting) the liquid storage chamber so that gas can pass via the air vent of the liquid storage chamber and the air vent of the support (connection) member by forming the air vent in the support (connection) member.

Preferably, the support (connection) member detachably connects (supports) the liquid storage chamber. In other words, the support (connection) member preferably includes a detachable section configured to detachably connect (support) the liquid storage chamber. When the support (connection) member detachably connects the liquid storage chamber, the film member and the liquid storage chamber can be replaced. Therefore, when the liquid to be discharged is changed, contamination of liquids can be prevented.

When the liquid discharge head or the liquid discharge apparatus is used to form a cell chip or a three-dimensional tissue, it may be necessary to discharge a plurality of liquids of different kinds by one liquid discharge head. At this time, preferably, both the film member and the liquid storage chamber are replaced when the liquid to be discharged is changed, and the film member and the liquid storage chamber are disposed of after use, in order to prevent contamination of the liquids of different kinds.

Japanese Unexamined Patent Application Publication No. 2015-3483 describes, for example, a disposable liquid storage chamber. However, this technique utilizes compression of liquid in a liquid chamber to form a liquid droplet. Therefore, when bubbles are included in a pressurization liquid chamber, the liquid cannot be compressed, and the liquid droplet cannot be discharged in some cases. Moreover, in the technique described in Japanese Unexamined Patent Application Publication No. 2015-3483, a piezoelectric element repeats collision with a displacement regulating plate via a pressure plate, and therefore the piezoelectric element may be broken.

When a liquid discharge head of the conventional technique (e.g., the liquid discharge head described in Japanese Unexamined Patent Application Publication No. 2016-116489) is used, a liquid storage chamber (a liquid droplet and a formation device in Japanese Unexamined Patent Application Publication No. 2016-116489) is provided with a displacement member such as a piezoelectric element. Therefore, the liquid discharge head of the conventional technique is not economical because when the film member and the liquid storage chamber are disposed of after use, an expensive displacement member is also disposed. Moreover, in the conventional liquid discharge head, the liquid storage chamber is provided with the displacement member. Therefore, when the film member and the liquid storage chamber are replaced (exchanged), works (e.g., removal and attachment of an electric wiring configured to drive the displacement member, and adjustment for preventing variation of operation in each piezoelectric element) are required. Therefore, the conventional liquid discharge head has a problem that replacement of the film member and the liquid storage chamber in a short time is difficult.

In the liquid discharge head of the present disclosure, in the embodiment where the support (connection) member detachably connects the liquid storage chamber, the film member and the liquid storage chamber are not provided with the displacement member because the displacement member displaces the whole position of the film member via the support (connection) member to discharge the liquid. Therefore, in this embodiment, when film member and the liquid storage chamber are replaced, the film member and the liquid storage chamber can be replaced in a short time by detachably connecting the support (connection) member to the liquid storage chamber.

In the case where the film member and the liquid storage chamber can be replaced in a short time, when a tissue formed of a plurality of cells is formed, a survival rate of the cells can be prevented from being decreased, which is particularly advantageous.

The detachable section is not particularly limited and may be appropriately selected depending on the intended purpose. Examples of the detachable section include: a detachable section where a screwing section such as a screw energizes and supports the liquid storage chamber; a detachable section where an elastic body energizes and supports the liquid storage chamber; and a detachable section where a magnetic body supports the liquid storage chamber by magnetic force. These may be used alone or in combination. Among them, as the detachable section, a detachable section where an elastic body energizes and supports the liquid storage chamber and a detachable section where a magnetic body supports the liquid storage chamber by magnetic force are preferable.

Preferably, the detachable section includes an elastic body, and the elastic body energizes the liquid storage chamber to unremovably support the liquid storage chamber. When the detachable section includes an elastic body and the elastic body energizes the liquid storage chamber to unremovably support the liquid storage chamber, the film member and the liquid storage chamber can be easily attached and replaced in a shorter time.

The elastic body is not particularly limited and may be appropriately selected depending on the intended purpose. Examples of the elastic body include rubbers, coil springs, leaf springs, and torsion bars. Among them, leaf springs are preferable. These may be used alone or in combination.

Note that, the phrase “unremovably support the liquid storage chamber” means that the liquid storage chamber is detachable by, for example, a user when the liquid storage chamber is replaced, but means that the connection member can connect (support) the liquid storage chamber when the liquid storage chamber and the connection member remain stationary and when displacement (vibration) is made by the displacement member.

Preferably, the detachable section includes a magnetic body, and the magnetic body unremovably supports the liquid storage chamber by magnetic force. When the detachable section includes a magnetic body and the magnetic body unremovably supports the liquid storage chamber by magnetic force, the film member and the liquid storage chamber can be easily attached and replaced in a shorter time.

The magnetic body means an article that generates a magnetic field. Examples of the magnetic body include permanent magnets and electromagnets. Among them, permanent magnets are preferable. These may be used alone or in combination.

In the liquid storage chamber, when the detachable section includes the magnetic body, it is preferable to include an attraction section that generates an attractive force between the attraction section and the connection member by magnetic force generated by the magnetic body. The attraction section is not particularly limited and may be appropriately selected depending on the intended purpose. Examples of the attraction section include metals of ferromagnetic bodies such as iron, cobalt, and nickel. These may be used alone or in combination.

In an aspect of the present disclosure, in a cross section of the film member in a thickness direction of the film member, the cross section of the edge of the film member forming the discharge hole has a curve shape. That is, when the edge of the discharge hole is made smooth and round, generation of residues can be prevented without disturbing flow of the liquid, and a position of meniscus constituted by the discharge hole, the liquid, and the atmosphere can be stabilized.

When the surface of the film member constituting the discharge hole is covered with a passive state, attachment of the liquid, particles contained in the liquid, and reactive components can be prevented. Therefore, the liquid discharge head of the present disclosure makes it possible to maintain meniscus in an intended state, and to stably continue discharging compared to the conventional liquid discharge heads.

### (Method for Producing Liquid Discharge Head)

A method of the present disclosure for producing a liquid discharge head is a method for producing the liquid discharge head of the present disclosure. The method of the present disclosure for producing a liquid discharge head includes a passive film forming step of subjecting the film member to a chemical polishing treatment to form a passive film on a surface of the film member, and further includes other steps if necessary.

The passive film forming step is a step of subjecting the film member to a chemical polishing treatment to form a passive film on a surface of the film member.

Here, the film member and the passive film are the same as those described in the aforementioned liquid discharge head of the present disclosure.

Examples of the chemical polishing treatment include a chemical liquid treatment using, for example, S-CLEAN S-250 (SASAKI CHEMICAL CO., LTD.).

The other steps are not particularly limited and may be appropriately selected depending on the intended purpose.

### (Liquid Discharge Apparatus)

A liquid discharge apparatus of the present disclosure includes the liquid discharge head of the present disclosure, preferably includes a driving unit and a particle number counting unit, and further includes other units if necessary.

The liquid discharge head in the liquid discharge apparatus of the present disclosure is the same as the liquid discharge head of the present disclosure. Therefore, its description is omitted herein.

### <Driving Unit>

The driving unit is not particularly limited and may be appropriately selected depending on the intended purpose. Examples of the driving unit include a unit configured to input a drive voltage to the liquid droplet discharging unit. In this case, it is possible to discharge minute liquid droplets, by a piezoelectric element deformed by the driving unit.

### <Particle Number Counting Unit>

The particle number counting unit is a unit configured to count the number of particles contained in liquid droplets, and is preferably a unit configured to count the number of particles contained in liquid droplets with a sensor after the liquid droplets are discharged and before the liquid droplets land on a landing target.

A sensor means a device configured to change mechanical, electromagnetic, thermal, acoustic, or chemical properties of natural phenomena or artificial products or spatial information/temporal information indicated by these properties into signals that are a different medium easily handleable by humans or machines, by utilizing some scientific principles.

The particle number counting unit is not particularly limited, and may be appropriately selected depending on the intended purpose. The particle number counting unit may include an operation for observing particles before discharging and an operation for counting particles after landing.

As an operation of counting the number of particles contained in the liquid droplets after the liquid droplets are discharged and before the liquid droplets land on the landing target, it is preferable to observe particles in a liquid droplet at a timing at which the liquid droplet is at a position that is immediately above a well opening and at which the liquid droplet is predicted to enter the well in a plate as the landing target without fail.

The plate is not particularly limited, and a plate that is commonly used in bio fields and in which holes are formed can be used.

The number of wells in the plate is not particularly limited and may be appropriately selected depending on the intended purpose. The number of wells may be a single number or a plural number.

As a plate with a plural number of wells, it is preferable to use plates in which holes having such number and dimension generally used in the field are formed (the number of wells are, for example, 24, 96, and 384).

A material of the plate is not particularly limited and may be appropriately selected depending on the intended purpose. The material is preferably a material that prevents cells or a nucleic acid from being attached to wall surfaces for a pre-treatment.

Examples of the method for observing particles in the liquid droplet include an optical detection method and an electric or magnetic detection method.

### <Other Units>

The other units are not particularly limited and may be appropriately selected depending on the intended purpose. Preferable examples of the other units include a control unit, a displaying unit, and a recording unit.

### EXAMPLES

Examples of the present disclosure will be described hereinafter. However, the present disclosure should not be construed as being limited to these Examples.

### Example 1

First, 3T3 cells were diluted with phosphate buffered saline (hereinafter, presented as PBS (−)) so that a final concentration thereof would be 3×10⁶ number/ml to prepare a cell suspension.

Next, a liquid discharge apparatus including a liquid discharge head presented in FIG. 1A to FIG. 1C was used with SUS304 (obtained from NIPPON STEEL Stainless Steel Corporation, curvature of a curve of an edge of the film member forming the discharge hole in a cross section of the film member in a thickness direction of the film member: 0.2, surface roughness (Ra): 100 nm) that is a film member. The film member was formed by subjecting it to a chemical polishing treatment using, for example, S-CLEAN S-250 (SASAKI CHEMICAL CO., LTD.) under stirring in a chemical liquid heated to about 100° C. and then forming a coating film (passive film) of chromium oxide on the surface thereof. The liquid discharge apparatus was used to discharge the prepared cell suspension under the following discharge conditions. The “continuous dischargeability” was evaluated in the following manner.

### -Discharge Conditions-

Discharge amount: 52 pL
Diameter of discharge hole: 100 μm
Diameter of liquid droplet: 100 μm

### <Continuous Dischargeability>

Under the above discharge conditions, the liquid discharge head was evaluated based on the following evaluation criteria. Results are presented in Table 1.

### [Evaluation Criteria]

A: Stable discharging could be performed in continuous discharging of 1 h or more (maintenance such as wiping the surface of the discharge hole (nozzle) was not performed).

B: Stable discharging could be performed in continuous discharging of 1 h or more (maintenance such as wiping the surface of the discharge hole (nozzle) was performed).

C: Stable discharging could be performed in continuous discharging of 0.4 h or more but less than 1 h (maintenance such as wiping the surface of the discharge hole (nozzle) was performed).

D: Stable discharging could be performed in continuous discharging of less than 0.4 h (maintenance such as wiping the surface of the discharge hole (nozzle) was performed).

### Examples 2 to 6, and Comparative Examples 1 to 2

A liquid discharge head was produced and the “continuous dischargeability” was evaluated in the same manner as in Example 1 except that the configuration of the liquid discharge head was changed as described in Table 1. Results were presented in Table 1.

Here, a liquid discharge head of Comparative Example 1 was produced in the same manner as in Example 1 except that the treatment temperature in the treatment method of the film member was changed to a low temperature (60° C. to 80° C.). A liquid discharge head of Comparative Example 2 was produced in the same manner as in Example 1 except that the processing method of the discharge hole in the treatment method of the film member was changed to a press processing to form a discharge hole; and a passive film was not formed without performing a chemical liquid treatment.

TABLE 1

| | Liquid discharge head | | | | |
|---|---|---|---|---|---|
| | | | Curvature of | | |
| | | | curve of edge of | | Evaluation |
| | | | film member | | criteria |
| | Material of | | forming discharge | Surface roughness | Continuous |
| | film member | Passive film | hole | Ra of film member | discharging |
| Ex. 1 | SUS304 | Chromium oxide | 0.2 | 100 nm | B |
| | | coating film | | | |
| Ex. 2 | SUS304 | Chromium oxide | 0.1 | 100 nm | A |
| | | coating film | | | |
| Ex. 3 | SUS304 | Chromium oxide | 0.2 | 50 nm | A |
| | | coating film | | | |
| Ex. 4 | SUS304 | Chromium oxide | 10 | 100 nm | C |
| | | coating film | | | |
| Ex. 5 | SUS304 | Chromium oxide | 0.2 | 150 nm | C |
| | | coating film | | | |
| Ex. 6 | SUS304 | Chromium oxide | 0.1 | 200 nm | C |
| | | coating film | | | |
| Comp. | SUS304 | Chromium oxide | — | 100 nm | D |
| Ex. 1 | | coating film | | | |
| Comp. | SUS304 | — | 0.2 | 100 nm | D |
| Ex. 2 | | | | | |

Aspects of the present disclosure are as follows, for example.

<1> A liquid discharge head including:

a film member including a discharge hole configured to discharge liquid; and

a displacement member configured to displace a position of the film member to discharge the liquid from the discharge hole,

wherein an edge of the film member forming the discharge hole has a curve in a cross section of the film member in a thickness direction of the film member, and

a surface of the film member includes a passive film.

<2> The liquid discharge head according to <1>,

wherein a curvature of the curve is 0.1 or more but 1 or less.

<3> The liquid discharge head according to <1> or <2>,

wherein the film member forming the discharge hole has a surface roughness (Ra) of 100 nm or less.

<4> The liquid discharge head according to any one of <1> to <3>,

wherein a material of the film member is stainless steel.

<5> The liquid discharge head according to any one of <1> to <4>,

wherein the liquid includes particles.

<6> A liquid discharge apparatus including

the liquid discharge head according to any one of <1> to <5>.

<7> A method for producing the liquid discharge head according to any one of <1> to <5>, the method including

subjecting the film member to a chemical polishing treatment to form the passive film.

The liquid discharge head according to any one of <1> to <5>, the liquid discharge apparatus according to <6>, and the method for producing the liquid discharge head according to <7> can solve the existing problems in the art and can achieve the object of the present disclosure.

What is claimed is:

1. A liquid discharge head comprising:
a film member including a discharge hole configured to discharge liquid; and
a displacement member configured to displace a position of the film member to discharge the liquid from the discharge hole,
wherein an edge of the film member forming the discharge hole has a curve in a cross section of the film member in a thickness direction of the film member, and
a surface of the film member includes a passive film.

2. The liquid discharge head according to claim 1,
wherein a curvature of the curve is 0.1 or more but 1 or less.

3. The liquid discharge head according to claim 1,
wherein the film member forming the discharge hole has a surface roughness (Ra) of 100 nm or less.

4. The liquid discharge head according to claim 1,
wherein a material of the film member is stainless steel.

5. The liquid discharge head according to claim 1,
wherein the liquid includes particles.

6. A liquid discharge apparatus comprising
the liquid discharge head according to claim 1.

7. A method for producing the liquid discharge head according to claim 1, the method comprising
subjecting the film member to a chemical polishing treatment to form the passive film on the surface of the film member.
